(19) United States
(12) Patent Application Publication
(10) Pub. No.: US 2002/0095513 A1
(43) Pub. Date: Jul. 18, 2002

(54) Multilayer lossless data compression across a network

(76) Inventors: Freddie Lin, Redondo Beach, CA (US); Igor V. Ternovskiy, Rancho Palos Verdes, CA (US)

Correspondence Address: NILES & NILES, S.C., INTELLECTUAL PROPERTY ATTORNEYS, FIRSTAR CENTER, SUITE 2000, 777 EAST WISCONSIN AVENUE, MILWAUKEE, WI, 53202-5345, US

(21) Appl. No.: 09/760,614

(22) Filed: Jan. 16, 2001

(51) Int. Cl. G06F 15/173; G06F 15/16

(52) U.S. Cl. 709/238; 709/247

(57) ABSTRACT

A method and apparatus for compressing and transmitting data across a network. Packets of data are received. The packets of data are combined based on packet header destination information to form a first combined file. The first combined file is compressed to form a first compressed file. The first compressed file is transmitting across the network. The first compressed file is repacketized to form a repacketized first compressed file and the repacketized first compressed file is transmitted across the network. The packets combined to form the first combined file have headers addressed to the same first subnetwork and the first subnetwork comprises a plurality of users. Headers addressed to the first subnetwork are inserted on the packets of the repacketized first compressed file. A second group of packets of data with headers addressed to a second subnetwork is selected. the second group of packets of data is combined to form a second combined file. The second combined file is compressed and transmitted.

### BACKGROUND OF THE INVENTION

1. Field of Invention

The present invention is directed to a method and apparatus for lossless data compression and transmission across a network.

2. Description of Related Art

Presently, networks are used for the transmission of data. To accommodate limited bandwidth and speed requirements, data is often compressed before transmission across a network. Because of cost and processing requirements, the data is often compressed off-line, stored as a compressed file, and then transmitted across the network.

Unfortunately, off-line compression does not accommodate real-time data because of the delays encountered in the compression, storing, and transmission process. For example, on-line stock traders require up to date stock quotes substantially instantaneous with the fluctuations in the stock prices. This requirement is not satisfied with off-line compression.

On-line compression may be used to compress data on -line. Unfortunately, high quality on-line real-time compression is expensive and therefore not available to the majority of users. Furthermore, on-line compression is not feasible unless both the sender and the receiver of the data employ the same compression algorithms. Thus, existing compression schemes are not effective for wide spread use by multiple users transmitting and receiving multiple formats of data.

### SUMMARY OF THE INVENTION

The present invention provides a method and apparatus for compressing and transmitting data in real-time across a network. According to one embodiment, packets of data are received. The packets of data are combined based on packet header destination information to form a first combined file. The first combined file is compressed using lossless compression to form a first compressed file. The first compressed file is repacketized to form a repacketized first compressed file and the repacketized first compressed file is transmitted across the network. The packets combined to form the first combined file have headers addressed to the same first subnetwork where the first subnetwork comprises a plurality of users. Headers addressed to the first subnetwork are inserted onto the packets of the repacketized first compressed file.

Furthermore, a second group of packets of data with headers addressed to a second subnetwork is selected. The second group of packets of data is combined to form a second combined file. The second combined file is compressed to form a second compressed file. The second compressed file is repacketized. Headers addressed to the second subnetwork are inserted on the packets of the repacketized second compressed file. Also, the first combined file is compressed according to a first compression algorithm and the second combined file is compressed according to a second compression algorithm. Additionally, the packets of data are received from a third subnetwork. Packets destined for at least one of the third subnetwork and a fourth subnetwork are ignored based on header destination information. Therefore, these packets are not compressed.

According to another embodiment, the present invention provides a method for transmitting data across a network including receiving packets of data, combining and compressing the packets of data destined for a first subnetwork according to a first compression algorithm to create a first compressed file, and combining and compressing the packets of data destined for a second subnetwork according to a second compression algorithm to create a second compressed file. The combining and compressing the packets of data destined for a first subnetwork step further includes compressing the packets of data destined for the first subnetwork according to a first compression algorithm based upon first header destination information. The combining and compressing the packets of data destined for a second subnetwork step further includes compressing the packets of data destined for the second subnetwork according to a second compression algorithm based upon second header destination information.

Furthermore, the method includes repacketizing the first compressed file, repacketizing the second compressed file, and transmitting the repacketized first compressed file and the repacketized second compressed file. The method also includes ignoring packets destined for a third subnetwork based on third header destination information. Thus, the packets destined for the third subnetwork are not compressed.

According to another embodiment, the present invention provides an apparatus for transmitting data across a network. The apparatus includes an input that receives packets of data, a controller that combines packets of data based on packet header destination information to form a first combined file, a first compressor the compresses the first combined file to form a first compressed file, and an output that outputs the first compressed file to the network. The controller repacketizes the first compressed file and the interface outputs the repacketized first compressed file to the network. The packets combined to form the first combined file have headers addressed to the same first subnetwork, the first subnetwork comprising a plurality of users. Also, the controller inserts headers addressed to the first subnetwork on the packets of the repacketized first compressed file.

The apparatus further includes a second compressor, and the controller selects a second group of packets of data with headers addressed to a second subnetwork and combines the second group of packets of data to form a second combined file, the second compressor compresses the second combined file to form a second compressed file, and the output transmits the second compressed file. Additionally, the controller repacketizes the second compressed file and the output transmits the repacketized second compressed file. The controller inserts headers addressed to the second subnetwork on the packets of the repacketized second compressed file. The first compressor compresses the first combined file according to a first compression algorithm and the second compressor compresses the second combined file according to a second compression algorithm. Also, the input receives the packets of data from a third subnetwork. The controller ignores packets destined for at least one of the third subnetwork and a fourth subnetwork based on header destination information.

According to another embodiment, the present invention provides an apparatus for transmitting data across a network including an input that receives packets of data and a controller that combines and compresses the packets of data destined for a first subnetwork according to a first compression algorithm to create a first compressed file, and combines and compresses the packets of data destined for a second subnetwork according to a second compression algorithm to create a second compressed file. The controller compresses the packets of data destined for the first subnetwork according to a first compression algorithm based upon first header destination information and compresses the packets of data destined for the second subnetwork according to a second compression algorithm based upon second header destination information.

The controller also repacketizes the first compressed file, repacketizes the second compressed file and transmits the first compressed file and the second compressed file. The controller further ignores packets destined for a third subnetwork based on third header destination information.

Thus, the present invention provides for a method and apparatus for providing real-time lossless data compression and transmission across a network. The method and apparatus is cost effective because the cost is absorbed by many users across a subnetwork. Furthermore, many users enjoy the benefits of the apparatus at the edge of the network because individual users are not required to purchase and configure a specific compression algorithm to accommodate other users. Also, throughput is increased because increased amounts of data can be transmitted through smaller bandwidths.

### BRIEF DESCRIPTION OF THE DRAWINGS

The preferred embodiments of the present invention will be described with reference to the following figures, wherein like numerals designate like elements, and wherein:

FIG. 1 is an exemplary block diagram of a system for compressing and transmitting data in real-time across a network according to a preferred embodiment;

FIG. 2 is an exemplary block diagram of an access device according to a preferred embodiment;

FIG. 3 is an exemplary block diagram of an access device according to another embodiment;

FIG. 4 is an exemplary flowchart outlining the operation of the access device according to a preferred embodiment; and

FIG. 5 is an exemplary block diagram illustrating the operation of the access device according to a preferred embodiment.

### DETAILED DESCRIPTION OF PREFERRED EMBODIMENTS

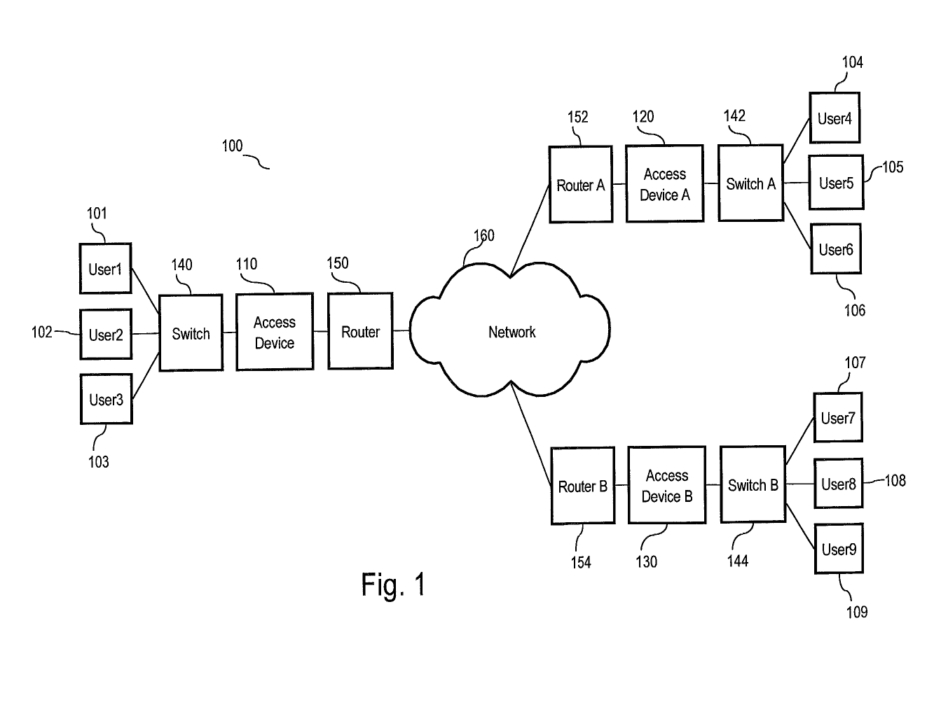

FIG. 1 is an exemplary block diagram of a system 100 for compressing and transmitting data in real-time across a network according to a preferred embodiment. The system 100 includes users 101-109, access devices 110, 120, and 130, switches 140, 142, and 144, routers 150, 152, and 154, and a network 160. Users 101-103 are a subnetwork. Similarly, users 104-106 and users 107-109 are subnetworks. For example, users 101-103 are a subnetwork such as a local area network (LAN), a wireless local area network (WLAN) a campus area network (CAN), an enterprise network (EN), or any other network that provides for the transmission of data. Additionally, each user may be individual terminals, individual subnetworks, or any other combination of terminals, users, and subnetworks. The users 104-106 create a first subnetwork A and the users 107-109 create a second subnetwork B.

The network 160 and the subnetworks are any type of network that is capable of sending and receiving communication signals. For example, the network 160 may include a packetized data network, such as the Internet, a metropolitan area network (MAN), a wide area network (WAN), a cable packet data network, and other like communication networks. The network 160 may also include a telecommunications network, such as a local telephone network, a long distance telephone network, a plain old telephone service (POTS), a public switched telephone network (PSTN), a cellular telephone network, a satellite communications network, and other like communications systems. Furthermore, the network 160 may include more than one network and may include a plurality of different types of networks. Thus, the network 160 may include a plurality of data networks, a plurality of telecommunications networks, a combination of data and telecommunications networks and other like communication systems.

The switches 140, 142, and 144 are, for example, asynchronous transfer mode (ATM) switches, Ethernet, Fast Ethernet and Gigabit Ethernet switches, internet protocol (IP) switches, or any other switches that perform network switching functionality. The switch 140, the access device 110, and the router 150 exist at the edge of the network 160. The access device 110 does not necessarily exist between the switch 140 and the router 150. For example, the access device 110 can exist between routers. Similarly, the router 152, the access device 120 and the switch 142 exist at the edge of the network 160 and the users 104-106 and the router 154, the access device 130 and the switch 144 exist at the edge of the network 160 and the users 107-109.

In operation, users 101-102 transmit data through the switch 140 to the access device 110. The access device 110 recognizes, combines, compresses, and repacketizes the data for transmitting across the network 160 depending on the destination subnetwork. For example, the access device 110 recognizes packets addressed to users 101-103 in subnetwork A based on packet header information. The access device then combines the packets, compresses the packets according to an appropriate compression algorithm that also exists at subnetwork A, repacketizes the compressed file, and sends the repacketized file to the access device 120. The access device 120 then combines the packets, uncompresses the file, recovers the original packets, and sends the packets to the appropriate user based on packet header information.

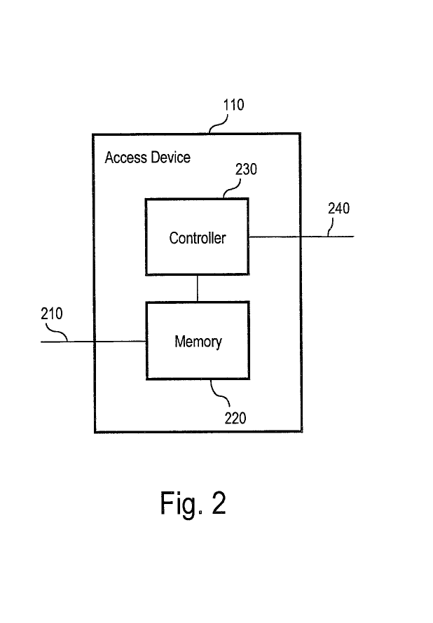

FIG. 2 is an exemplary block diagram of an access device 110 according to a preferred embodiment. The access device 110 includes an input 210, a memory 220, a controller 230, and an output 240. The input 210 and the output 240 can be network interfaces. In operation, the input 210 receives packets of data. The memory 220 acts as a buffer for the controller 230. The controller 230 recognizes, combines, compresses, and repacketizes the received packets based on packet header destination information. Such header destination information can be any information useful for identifying the destination user or the destination subnetwork of a received packet. In particular, the controller 230 performs operations on selected packets based on packet header destination information indicating that the selected packets are destined for a selected subnetwork. The output 240 then transmits the packets across a network.

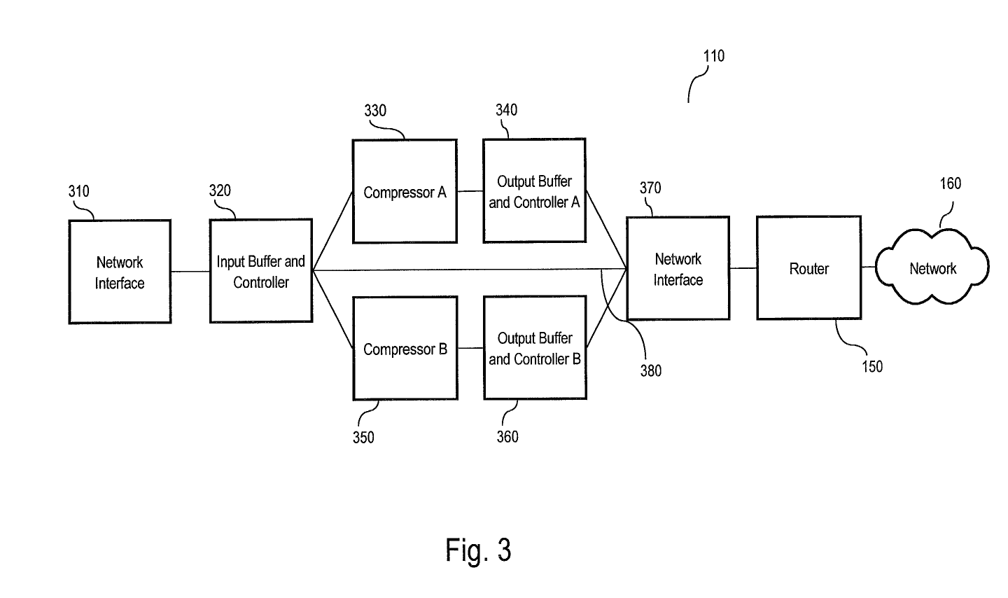

FIG. 3 is an exemplary block diagram of an access device 110 according to another embodiment. The access device 110 includes a network interface 310, a network buffer and controller 320, compressors 330 and 350, output buffer and controllers 340 and 360, a direct path 380, and a network interface 370. In operation, the network interface 310 receives packets of data. The input buffer and controller 320 combines the packets of data based on packet header destination information and filters the combined packets to the compressors 330 and 350 based on the header destination information. For example, the input buffer and controller 320 combines and filters the packets based on which subnetwork the packets are addressed to. The compressor 330 compresses the combined packets of data destined for the subnetwork A. The compressor 330 compresses the combined packets according to an optimal compression algorithm that is present at the access device 120 for the subnetwork A. The output buffer and controller 340 repacketizes compressed file and buffers the repacketized data for output. For example, the output buffer and controller 340 repacketizes the compressed file and inserts headers addressed to subnetwork A on the packets. The network interface 370 acts as an interface for outputting the packets to the router 150 and the network 160. The compressor 350 and the output buffer and controller 360 operate in a similar manner for packets addressed to subnetwork B.

The path 380 passes ignored packets. For example, the input buffer and controller 320 recognizes packets addressed to subnetworks without decompressors, addressed to unknown subnetworks, or the like. The input buffer and controller 320 then sends the recognized packets along the path 380 to the network interface 370 for transmittal across the network 160 with compression. Additional compressor and output buffer and controller circuitry can be added for additional subnetworks.

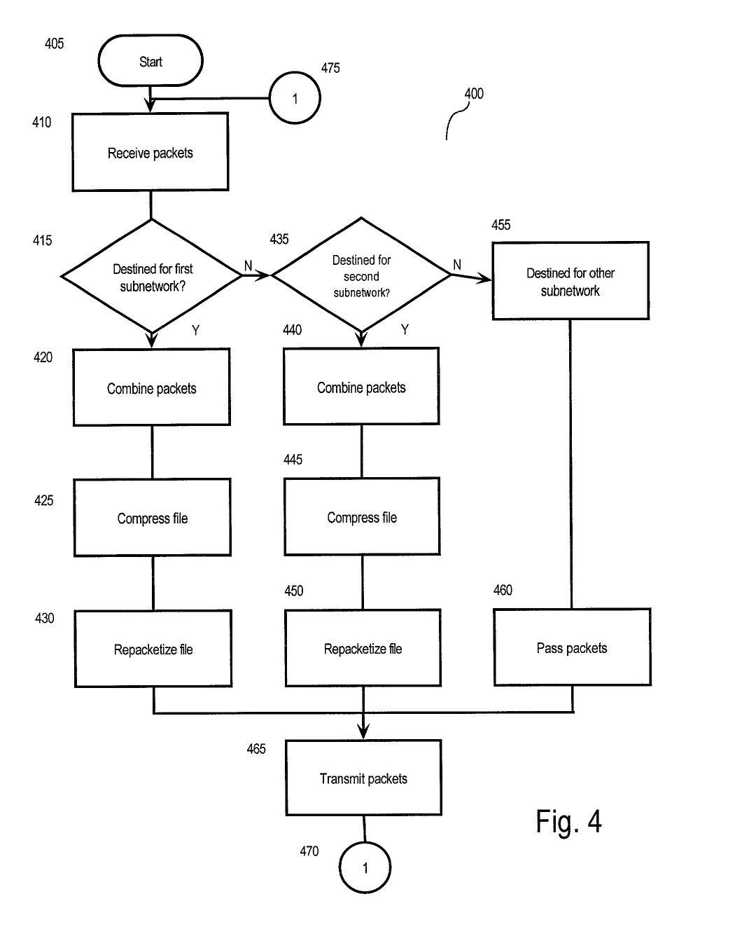

FIG. 4 is an exemplary flowchart 400 outlining the operation of the access device 110 according to a preferred embodiment. The flowchart begins in step 405. In step 410, the access device 110 receives packets of data. In step 415, the access device determines if the packets of data are destined for the first subnetwork A. If the packets are destined for subnetwork A, in step 420 the access device 110 combines the packets to form a combined file. For example, the access device 110 combines a determined or predetermined amount of packets or combines the packets for a predetermined time to form the combined file. Preferably, the access device 110 combines more than one packet, but less than an amount of packets that would cause an unacceptable delay. The more packets that are combined for compression, the more efficient the compression will be. For example, approximately 20-50 packets are compressed to obtain efficient compression without unnecessary delay.

In step 425, the access device 110 compresses the combined file to form a compressed file. In particular, the access device 110 compresses the combined file according to a compression/decompression algorithm used at subnetwork A. Preferably, the access device 110 compresses the combined file according to a compression/decompression algorithm used by the access device 120 at the edge of subnetwork A on the packets of the repacketized file. In step 430, the access device 110 repacketizes the compressed file. The access device 110 includes a header on the new packets addressed to subnetwork A. For example, the header is addressed to the access device 120, the switch 142, or any other useful device located at subnetwork A.

If the packets are not destined for subnetwork A, in step 435, the access device determines if the packets of data are destined for the second subnetwork B. If the packets are destined for subnetwork B, in step 440 the access device 110 combines the packets to form a combined file. In step 445, the access device 110 compresses the combined file to form a compressed file. In particular, the access device 110 compresses the combined file according to a compression/decompression algorithm used at subnetwork B. Preferably, the access device 110 compresses the combined file according to a compression/decompression algorithm used by the access device 130 at the edge of subnetwork B. In step 450, the access device 110 repacketizes the compressed file. The access device 110 includes a header addressed to subnetwork B on the packets of the repacketized file. For example, the header is addressed to the access device 130, the switch 144, or any other useful device located at subnetwork A. Additional determination steps such as step 435 can be used for additional subnetworks.

If the packets are not destined for subnetwork B, in step 455, the access device 110 determines that the packets are destined for another subnetwork. For example, the packets are destined for a third subnetwork such as a subnetwork without an access device, or the packets are destined for a fourth subnetwork such as unknown subnetwork or unknown user. In step 460, the access device 110 passes the packets. In particular, the access device ignores the packets and does not combine or compress the packets.

In step 465, the access device 110 transmits the packets to the router 150 and then across the network 160. In step 470, the access device 110 returns to step 475 to continue the process. All of the steps in the flowchart 400 are done substantially concurrently.

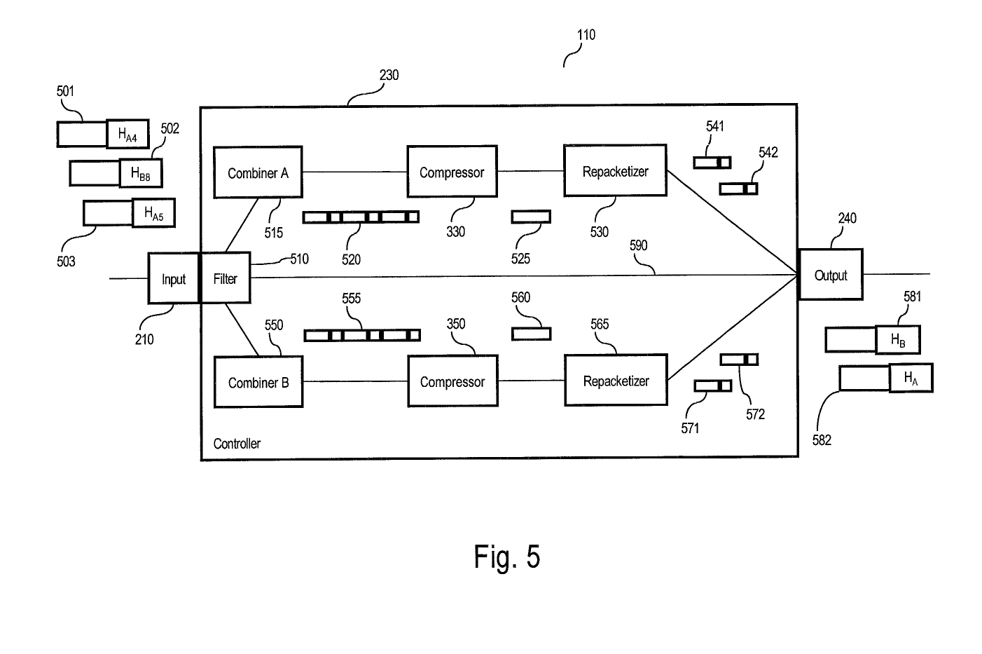

FIG. 5 is an exemplary block diagram illustrating the operation of the access device 110 according to a preferred embodiment. The access device 110 includes an input 210, an output 240 and a controller 230 including a filter 510, combiners 515 and 550, compressors 330 and 350, and repacketizers 530 and 565. The input 210 and output 240 can be network interfaces. In operation, the input 210 receives packets of data 501-503. For example, the input 210 receives packets of data from the users 101-103. The received packets of data 501-503 have headers addressed to destination users. For example, the packet 501 contains header destination information addressed to user4 104 located at subnetwork A, the packet 502 contains header destination information addressed to user8 108 located at subnetwork B, and the packet 503 contains header destination information addressed to user5 105 located at subnetwork A. The filter utilizes a filter, a mask, or the like to filter the packets to the correct paths based on the header destination information. For example, the filter filters the packet 501 to the combiner A 515 because the packet 501 is destined for subnetwork A. The combiner 515 accumulates and combines the packets destined for subnetwork A. For example, the combiner accumulates packet 503, packet 501, and other packets to form the combined file 520. The combiner accumulates a determined or predetermined number of packets or accumulates packets for a determined time period and then combines the packets. For example, the combiner 515 accumulates approximately 20-50 packets. The combiner 515 then outputs the combined file 520 to the compressor 530.

The compressor 530 compresses the combined file 520 according to a compression/decompression algorithm also located at subnetwork A. The compressor 530 then sends the compressed file 525 to the repacketizer 530 which repacketizes the file as packets 541-542 and inserts headers addressed to subnetwork A. The repacketizer then sends the packets 541-542 to the output 240 for output to the network. The output 240 outputs the packets 581-582 from the various paths of the controller 230. For example, packet 582 is outputted with header destination information having an address of subnetwork A.

The combiner 550, file 555, compressor 350, and repacketizer 565 operate similarly to the above elements, but are directed to subnetwork B. For example, the combiner 550 receives and combines packets such as packet 502 and sends the combined file 555 to the compressor 350. The compressor 350 compresses the combined file 555 and sends the compressed file 560 to the repacketizer 565. The repacketizer packetizes the compressed file 560 and sends the packets 571 and 572 to the output 240 for output to the network. For example, packet 581 is outputted with header destination information having an address of subnetwork B. The path 590 is used to pass packets, addressed to unknown subnetworks, or addressed to subnetworks without compression circuitry or software.

The method of this invention is preferably implemented on a programmable network processor. However, the access device 110 may also be implemented on a general purpose or special purpose computer, a programmed microprocessor or microcontroller and peripheral integrated circuit elements, an ASIC or other integrated circuit, a hardware electronic or logic circuit such as a discrete element circuit, a programmable logic device such as a PLD, PLA, FPGA or PAL, or the like. In general, any device on which resides a finite state machine capable of implementing the flowcharts shown in the Figures may be used to implement the controller functions of this invention.

While this invention has been described with specific embodiments thereof, it is evident that many alternatives, transformations, transpositions, modifications, and variations will be apparent to those skilled in the art. For example, various features of different embodiments of the invention can be combined and interchanged. Accordingly, the preferred embodiments of the invention as set forth herein are intended to be illustrative, not limiting. Various changes may be made without departing from the spirit and scope of the invention.

What is claimed is:

1. A method for transmitting data across a network comprising:
receiving packets of data;
combining the packets of data based on packet header destination information to form a first combined file;
compressing the first combined file to form a first compressed file; and
transmitting the first compressed file.

2. The method for transmitting data across a network according to claim 1, further comprising repacketizing the first compressed file, wherein the transmitting step transmits the repacketized first compressed file.

3. The method for transmitting data across a network according to claim 1, wherein the packets combined to form the first combined file have headers addressed to the same first subnetwork, the first subnetwork comprising a plurality of users.

4. The method for transmitting data across a network according to claim 3, further comprising inserting headers addressed to the first subnetwork on the packets of the repacketized first compressed file.

5. The method for transmitting data across a network according to claim 3, further comprising:
selecting a second group of packets of data with headers addressed to a second subnetwork;
combining the second group of packets of data to form a second combined file;
compressing the second combined file to form a second compressed file; and
transmitting the second compressed file.

6. The method for transmitting data across a network according to claim 5, further comprising repacketizing the second compressed file, wherein the transmitting step transmits the repacketized second compressed file.

7. The method for transmitting data across a network according to claim 6, further comprising inserting headers addressed to the second subnetwork on the packets of the repacketized second compressed file.

8. The method for transmitting data across a network according to claim 5, wherein the compressing steps compress the first combined file according to a first compression algorithm and compress the second combined file according to a second compression algorithm.

9. The method for transmitting data across a network according to claim 1, wherein the receiving step receives the packets of data from a third subnetwork.

10. The method for transmitting data across a network according to claim 1, further comprising ignoring packets destined for at least one of the third subnetwork and a fourth subnetwork based on header destination information.

11. A method for transmitting data across a network comprising:
receiving packets of data;
combining and compressing the packets of data destined for a first subnetwork according to a first compression algorithm to create a first compressed file; and
combining and compressing the packets of data destined for a second subnetwork according to a second compression algorithm to create a second compressed file.

12. The method for transmitting data across a network according to claim 11, wherein
the combining and compressing the packets of data destined for a first subnetwork step further comprises compressing the packets of data destined for the first subnetwork according to a first compression algorithm based upon first header destination information and the combining and compressing the packets of data destined for a second subnetwork step further comprises compressing the packets of data destined for the second subnetwork according to a second compression algorithm based upon second header destination information.

13. The method for transmitting data across a network according to claim 11, further comprising:
repacketizing the first compressed file;
repacketizing the second compressed file; and
transmitting the packets of the repacketized first compressed file and the packets of the repacketized second compressed file.

14. The method for transmitting data across a network according to claim 11, further comprising ignoring packets destined for a third subnetwork based on third header destination information.

15. An apparatus for transmitting data across a network comprising:
an input that receives packets of data;
a controller that combines packets of data based on packet header destination information to form a first combined file;
a first compressor that compresses the first combined file to form a first compressed file; and
an output that outputs the first compressed file to the network.

16. The apparatus for transmitting data according to claim 15, wherein the controller repacketizes the first compressed file and the interface outputs the repacketized compressed file to the network.

17. The apparatus for transmitting data across a network according to claim 15, wherein the packets combined to form the first combined file have headers addressed to the same first subnetwork, the first subnetwork comprising a plurality of users.

18. The apparatus for transmitting data across a network according to claim 17, wherein the controller inserts headers addressed to the first subnetwork on the packets of the repacketized first compressed file.

19. The apparatus for transmitting data across a network according to claim 17, further comprising a second compressor, wherein the controller selects a second group of packets of data with headers addressed to a second subnetwork and combines the second group of packets of data to form a second combined file, the second compressor compresses the second combined file to form a second compressed file, and the output transmits the second compressed file.

20. The apparatus for transmitting data across a network according to claim 19, wherein the controller repacketizes the second compressed file and the output transmits the repacketized second compressed file.

21. The apparatus for transmitting data across a network according to claim 20, wherein the controller inserts headers addressed to the second subnetwork on the packets of the repacketized second compressed file.

22. The apparatus for transmitting data across a network according to claim 19, wherein the first compressor compresses the first combined file according to a first compression algorithm and the second compressor compresses the second combined file according to a second compression algorithm.

23. The apparatus for transmitting data across a network according to claim 15, wherein the input receives the packets of data from a third subnetwork.

24. The apparatus for transmitting data across a network according to claim 15, wherein the controller ignores packets destined for at least one of the third subnetwork and a fourth subnetwork based on header destination information.

25. An apparatus for transmitting data across a network comprising:
an input that receives packets of data; and
a controller that combines and compresses the packets of data destined for a first subnetwork according to a first compression algorithm to create a first compressed file, and combines and compresses the packets of data destined for a second subnetwork according to a second compression algorithm to create a second compressed file.

26. The apparatus for transmitting data across a network according to claim 25, wherein the controller further compresses the packets of data destined for the first subnetwork according to a first compression algorithm based upon first header destination information and compresses the packets of data destined for the second subnetwork according to a second compression algorithm based upon second header destination information.

27. The apparatus for transmitting data across a network according to claim 25, wherein the controller repacketizes the first compressed file, repacketizes the second compressed file and transmits the packets of the repacketized first compressed file and the packets of the repacketized second compressed file.

28. The apparatus for transmitting data across a network according to claim 25, wherein the controller ignores packets destined for a third subnetwork based on third header destination information.
